(19) United States
(12) Patent Application Publication
(10) Pub. No.: US 2026/0089649 A1
(43) Pub. Date: Mar. 26, 2026

(54) Transmit Power Normalization in Joint Transmission and Distributed Multi-User MIMO

(71) Applicant: Telefonaktiebolaget LM Ericsson (publ), Stockholm (SE)

(72) Inventors: Dennis Sundman, Sollentuna (SE); Charlie Pettersson, Solna (SE); Miguel Lopez, Aachen (DE); Leif Wilhelmsson, Lund (SE); Guido Roland Hiertz, Aachen (DE); Abhishek Ambede, Huddinge (SE)

(21) Appl. No.: 19/106,943

(22) PCT Filed: Sep. 1, 2022
(86) PCT No.: PCT/EP2022/074331

§ 371 Date: Feb. 26, 2025

(51) Int. Cl. H04W 52/36; H04B 7/024; H04W 52/42

(52) U.S. Cl. CPC H04W 52/367; H04B 7/024; H04W 52/42

(57) ABSTRACT

The present disclosure describes techniques for scaling the precoder output in an antenna system implementing joint transmission to control the total power emitted by a plurality of antennas distributed among multiple antennas. The scaling factor used for scaling the transmit power at each antenna comprises a parameter, N_{AP}, indicating a number of APs in the antenna system. In introduction of the parameter, N_{AP}, enables the scaling factor to be designed such that the total sum power does not increase when additional APs are added to the antenna system.

### TECHNICAL FIELD

The present disclosure relates generally to joint transmission in a wireless communication antenna system and, more particularly, to beamforming precoder normalization for distributed multi-user, multiple input, multiple output (D-MU-MIMO) systems.

### BACKGROUND

The Institute of Electrical and Electronics Engineers (IEEE) publishes standards for a wireless communication technology called Wireless Fidelity (Wi-Fi). In IEEE 802.11, a technology called joint transmission (JT) has been discussed in the Extremely High Throughput (EHT) Task Group (TG). JT is the concurrent data transmission from multiple coordinated access points (APs) to one or more user equipment (UE) using multiple input, multiple output (MIMO) transmission. With JT, multiple APs transmit simultaneously to one, or several, intended receivers. The main idea behind JT is to enable a completely distributed multi-user MIMO (D-MU-MIMO) deployment where antennas from multiple APs operate as if they were part of a single distributed antenna system.

In the European Union (EU), the 5.15 GHz to 5.35 GHz and 5.47 GHz to 5.725 GHz band is available for license-exempt use. Except for the 5.15 GHz to 5.25 GHz range, wireless devices (e.g., UEs 30) must employ Dynamic Frequency Selection (DFS) to protect flight and weather radars that operate as incumbent services in the 5 GHz band. DFS enables license-exempt equipment to detect radar signals and to avoid interfering with them. In other regulatory domains, such as the United Kingdom and the United States, similar rules for operating in the 5 GHz spectrum exist. Furthermore, Earth Exploration Satellite Services (EESS)-which cannot be detected by license-exempt equipment-use the 5 GHz band and thus, regulatory requirements demand that “the DFS mechanism shall also ensure, on average, a near-uniform spread of the loading of the spectrum.” This spreading helps reduce the aggregate emission levels of license-exempt equipment to EESS and other satellite services. An overview of the 5 GHz spectrum requirements is shown in FIG. 8.

It is expected that Wi-Fi devices may cause interfere to incumbents operating in the license-exempt 6 GHz band. Therefore, regulatory bodies around the world define special device classes for these license-exempt frequency band. For example, the EU defines a very low power (VLP) and a low power indoor (LPI) operating category, and the US defines an LPI as well as a standard power operating class. The latter requires wireless devices to adhere to an automatic frequency coordination (AFC) function in order to not cause harmful interference to incumbent services.

Current rules and regulations for use of unlicensed spectrum are formed with the assumptions that one transmitting device in an antenna system operates at a time. When Wi-Fi was introduced in the 5 GHz band, incumbent technologies experienced severe interference problems. Recently, Wi-Fi also gained access to parts of the 6 GHz band, where new coexistence problems may arise.

Using multi-AP techniques such as JT, the number of simultaneous transmitters in the antenna system may significantly increase in the downlink (DL). Normally an AP has an upper limit on the total number of antennas it can have (for example 8 with IEEE 802.1 lax). However, using JT, the total number of antennas increases with each AP that is added so that that the total emitted power of the antenna system also increases. With JT, the total power could scale infinitely. By allowing full-power JT, a Wi-Fi antenna system may, with current regulations, increase its power without limits by adding APs to the antenna system, which may cause severe problems to incumbent services.

### SUMMARY

The present disclosure relates to joint transmission to one or more receiving stations using an antenna system, such as an antenna system operating according to the IEEE 802.11 family of standards. The disclosure comprises techniques for scaling the precoder output for the antenna system implementing joint transmission to control the total power emitted by a plurality of antennas distributed among APs. The scaling factor used for scaling the transmit power at each antenna includes a parameter, N_{AP}, indicating a number of APs in the antenna system. In introduction of the parameter, N_{AP}, enables the scaling factor to be designed such that the total sum power does not increase when additional APs are added to the antenna system. In some embodiments, the scaling factor is a combined scaling factor SK comprising a product of a first scaling factor K, referred to as the power normalization factor, and a second scaling factor S, referred to as the power scaling factor. In some embodiments, the parameter, N_{AP}, is contained in the power normalization factor K. In others, the parameter, N_{AP}, is contained in the second scaling factor.

A first aspect of the disclosure comprises methods of controlling the transmit power in an antenna system including a plurality of antennas distributed among multiple APs and configured to perform joint transmission to one or more receiving stations. In one embodiment, the method comprises scaling precoder output for multiple spatial streams to be transmitted by the plurality of antennas by at least one scaling factor to adjust the sum power of the antenna system. The at least one scaling factor comprises a parameter, N_{AP}, indicating a number of APs in the antenna system.

A second aspect of the disclosure comprises a power scaling unit for controlling the transmit power in an antenna system including a plurality of antennas distributed among multiple APs and configured to perform joint transmission to one or more receiving stations. In one embodiment, the JT precoder is configured to scale the precoder output for multiple spatial streams to be transmitted by the plurality of antennas by at least one scaling factor to adjust the sum power of the antenna system. The at least one scaling factor comprises a parameter, N_{AP}, indicating a number of APs in the antenna system.

A third aspect of the disclosure comprises an access point (AP) including a power scaling unit for controlling the transmit power in an antenna system including a plurality of antennas distributed among multiple APs and configured to perform joint transmission to one or more receiving stations. In one embodiment, the JT precoder comprises communication circuitry for sending scaled precoder output to APs in the antenna system and processing circuitry. The processing circuitry is configured to scale precoder output for multiple spatial streams to be transmitted by the plurality of antennas by at least one scaling factor to adjust the sum power of the antenna system. The at least one scaling factor comprises a parameter, N_{AP}, indicating a number of APs in the antenna system.

A fourth aspect of the disclosure comprises a computer program for a power scaling unit in an antenna system including a plurality of antennas distributed among multiple APs. The computer program comprises executable instructions that, when executed by processing circuitry in the power scaling unit, causes the power scaling unit to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

### BRIEF DESCRIPTION OF THE DRAWINGS

FIG. 1 illustrates an exemplary wireless antenna system implementing JT as herein described.

FIG. 2 illustrates a system model for emitted power by an AP with multiple antennas.

FIG. 3 illustrates the radiated power from an ideal isotopically radiating antenna.

FIGS. 4A and 4B illustrate two examples of the spatial power distribution using the FPN method.

FIGS. 5A and 5B illustrate two examples of the spatial power distribution using the ELN method.

FIGS. 6A and 6B illustrate the emitted power in an exemplary system using a centralized precoder.

FIGS. 7A and 7B illustrate the emitted power in an exemplary system using a distributed precoder.

FIG. 8 illustrates 5 GHz spectrum requirements.

FIG. 9 illustrates a system model for emitted power in an antenna system implementing a JT scheme.

FIG. 10 illustrates a centralized architecture for an antenna system.

FIG. 11 illustrates a centralized architecture for an antenna system.

FIG. 12 illustrates an exemplary method performed by an AP in a wireless antenna system implementing JT.

FIGS. 13A-13D illustrates emitted power in an antenna system using conventional scaling where N_{AP}=4 and N_{Tx}=4.

FIGS. 14A-14D illustrates emitted power in an antenna system using enhanced scaling where N_{AP}=4 and N_{Tx}=4 FIGS. 15A-15D illustrates emitted power in an antenna system using enhanced scaling where N_{AP}=4 and N_{Tx}=1.

FIGS. 16A-16D illustrates emitted power in an antenna system using enhanced scaling where N_{AP}=4 and the APs 20 have different numbers of antennas.

FIG. 17 illustrates an exemplary enhanced scaling method implemented by an AP.

FIG. 18 illustrates a JT precoder in an antenna system including plurality of antennas distributed among multiple access points and configured to perform joint transmission to one or more receiving stations.

FIG. 19 illustrates a power scaling unit for controlling the transmit power in an antenna system including plurality of antennas distributed among multiple access points and configured to perform joint transmission to one or more receiving stations.

FIG. 20 illustrates an AP in an antenna system including plurality of antennas distributed among multiple access points and configured to perform joint transmission to one or more receiving stations.

### DETAILED DESCRIPTION

The present disclosure relates generally to JT in wireless communication networks with a distributed antenna system 10. Example embodiments will be described in the context of a wireless local area network (WLAN) operating according to the IEEE 802.11 family of standards. Those skilled in the art will appreciate, however, that the techniques herein described are more generally applicable to any type of wireless communication antenna system 10 that uses joint transmission including without limitation Long term Evolution (LTE) based on Fourth Generation (4G) standards and Fifth Generation (5G) networks using the New Radio (NR) air interface.

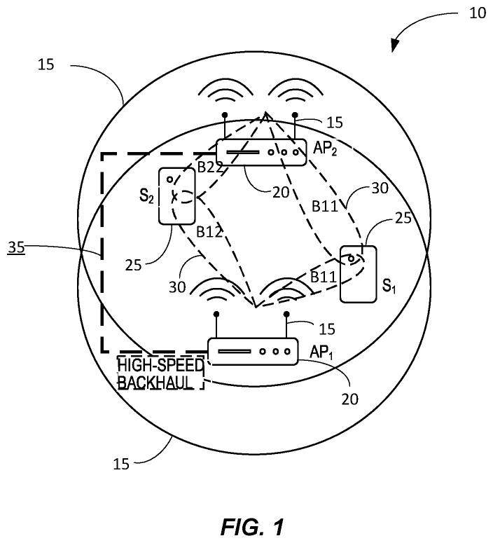

FIG. 1 illustrates an exemplary antenna system 10 comprising two APs 20, each with multiple antennas 15, serving respective cells 5 in a WLAN with overlapping coverage areas. The APs 20 communicates with receiving stations 25 within the antenna system 10 using beamforming with directional beams 30. As shown in FIG. 1, AP1 communicates with UE1 and UE2 using beams E11 and B12 respectively. AP2 communicates with UE1 and UE2 using beams B21 and B22 respectively.

Throughout this document, we assume all antenna elements are ideal isotropic radiating antennas. The power amplifier (PA) provides a transmit power of 100 mW, which can also be expressed as 20 dBm. The carrier frequency is f=5 GHz. For illustration purposes, free space propagation is assumed, in which the signal power from a single antenna 15 at distance d [m] is given by:

$$20 [ dBm ] - 10 {log}_{10} ( {( \frac{4 π df}{c} )}^{2} ) = 10 {log}_{10} ( {( 10 \frac{c}{4 π fd} )}^{2} ) , \qquad Eq . ( 1 )$$

where c [m/s] is the speed of light. With multiple antennas 15, the signal phase should be considered when calculating the received power at a given location. Assuming N_{TX} antennas 15 and perfect phase synchronization among all antennas 15, the received power at a given distance d can be denoted as P_{RX}:

$${P}_{R X} = 10 {log}_{10} ( {( 10 \frac{c}{4 π f} \vert {\sum }_{n = 1}^{{N}_{TX}} \frac{{e}^{- \frac{j 2 π {fd}_{n}}{c}}}{{d}_{n}} \vert )}^{2} ) . \qquad Eq . ( 2 )$$

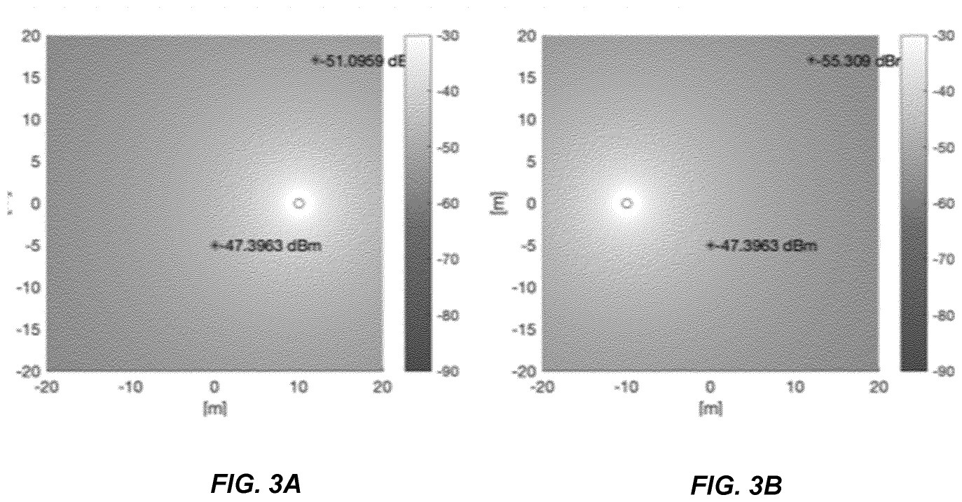

Using the above notation, two illustrations of the radiated power from an ideal isotopically radiating antenna 15 are illustrated in FIGS. 3A and 3B. In FIG. 3A, an AP 20 is placed at [10, 0]. and in FIG. 3B, the AP 20 is placed at [−10,0]. The shading represents power, and the received power is displayed at the location of two receiving stations (STA) in each scenario. Note that in both cases, the STA placed at [0,5] is at the same distance from the AP 20.

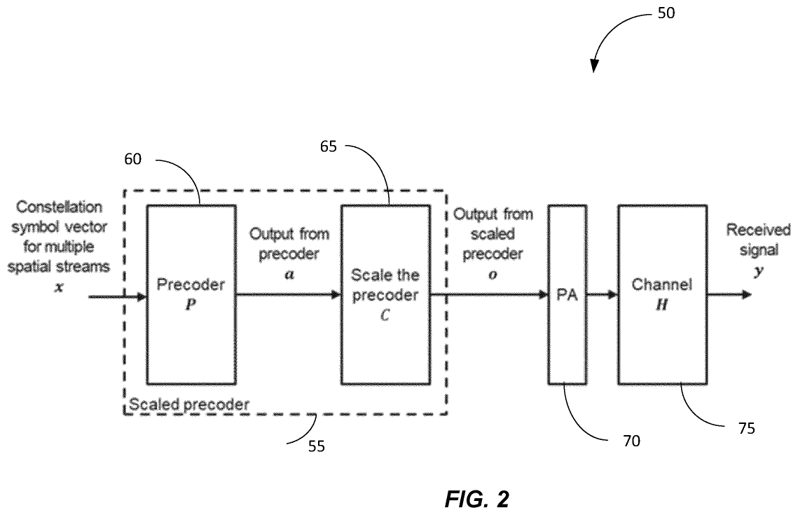

FIG. 2 illustrates a system model 50 for an antenna system 10 implementing a JT scheme. The main elements in the model 50 comprise a scaled precoder 55 including a precoder 60 and power scaling unit 65, power amplifier (PA) 70, and channel 75. A constellation symbol vector x for multiple spatial streams is input to the scaled precoder 55. The precoder 60 precodes the symbols in the symbol vector x and generates a precoder output α. Power scaling unit 65 scales the precoder output and outputs the scaled precoder output to the PA 70. The PA 70 amplifies the precoder output and outputs the amplified signal to the antennas 15 for transmission over the channel 75. Based on this model, the received signal at the receiving station 25 is given by:

$$y = HACPx , \qquad Eq . ( 3 )$$

where H_{N}_{_{RX}}_{,N}_{_{TX}} is the channel matrix, A is the power scaling applied by the PA 70, C is a regulatory scaling factor, P_{N}_{_{TX}}_{,N}_{_{SS}} is the precoder, and x_{N}_{_{SS}} is a vector with one constellation symbol per spatial stream. The power emitted from the transmitter is measured in W (typically dB relative to 1 mW, dBm) and we assume that each antenna element has one PA 70 with a maximum transmit power (full output power) of for example 20 dBm (100 mW). We refer to the input to the PA as the “fractional power,” which means that if the PA 70 is provided a fractional power 1, it will emit 20 dBm. If there are two antennas 15, the sum output power is 23 dBm and the sum fractional power is 2. In this document, we mostly use the fractional power, but in the figures the output power is also shown.

It is assumed that the constellation symbols are statistically independent and are generated from a constellation mapping such that E{xₙ}=0 and E{|xₙ|²}=1.

In this model, the task of the precoder is to steer one or many spatial streams such that independent data can be put into said spatial streams to be received at the intended receiver(s). Assume there are N_{TX} transmit antennas 15 at an AP 20, N_{RX} receive antennas 15 (possibly at different receiving stations 25) and N_{SS} spatial streams. The channel matrix is denoted H_{RX,TX}. In this document, the “sum-power of the system” refers to the power provided to the analog front-ends of the APs 20. The power amplifying term A is not included.

An example of a precoder P⁻ is the zero-forcing precoder, which solves the problem:

$$H {P}^{-} = I , \qquad Eq . ( 4 )$$

where I is the identity matrix. One solution to P⁻ is by the Moore-Penrose inverse,

$${P}^{-} = {H}^{+} = {{H}^{*} ( {HH}^{*} )}^{- 1} . \qquad Eq . ( 5 )$$

Other common precoders are the MMSE (minimum mean squared error) precoder or the MRT (maximum ratio transmission) precoder. The analysis described herein for these precoders should be similar to the zero-forcing precoder. There are two main methods to further modify the precoder:

Ensure that each data stream is served with the same power (transmit fairness). This can be done through column-vector normalization of P⁻. We refer to a column normalized precoder as P⁰.

Ensure that each data stream is received with the same power (receive fairness). This can be done through scaling P⁻ with a parameter such that the power of the largest row-vector is limited to 1. We refer to a largest row-vector normalized-precoder as P¹.

Using this model, we will use P⁰ as an example.

With this notation, the output from the normalized precoder a, may be described as,

$$a = [ {p}_{1}^{0} … {p}_{{N}_{ss}}^{0} ] [ \begin{matrix}{x}_{1} \\ ⋮ \\ {x}_{{N}_{ss}}\end{matrix} ] = {\sum }_{n = 1 … {N}_{s s}} {p}_{n}^{0} {x}_{n} , \qquad Eq . ( 6 )$$

where

$${p}_{n}^{0}$$

are the Columns of P⁰, and they are normalized such that

$$\vert {p}_{n}^{0} \vert = 1 , ∀ n \qquad Eq . ( 7 )$$

### Thus,

$$E \{ {\vert {P}_{t , n}^{0} \vert}^{2} \} = \frac{1}{{N}_{T X}} ∀ t , n , \qquad Eq . ( 8 )$$

where

$${P}_{t , n}^{0}$$

are the components of P⁰. By using the assumption on the constellation symbols and Eq. 8, the following relation is obtained,

$$E \{ {\vert {a}_{t} \vert}^{2} \} = E \{ {\vert {P}_{t , 1}^{0} {x}_{1} \vert}^{2} + … + {\vert {P}_{t , {N}_{SS}}^{0} {x}_{{N}_{SS}} \vert}^{2} \} = \frac{{N}_{SS}}{{N}_{TX}} . \qquad Eq . ( 9 )$$

### Thus,

$$E \{ {\vert a \vert}^{2} \} = E \{ {\sum }_{t = 1 … {N}_{T X}} {\vert {a}_{t} \vert}^{2} \} = {N}_{S S} . \qquad Eq . ( 10 )$$

These derivations are used herein to describe the design the scaling parameters.

A precoder with normalized columns as P⁰, is given by:

$${P}^{0} = [ \frac{{p}_{1}^{-}}{\vert {p}_{1}^{-} \vert} … \frac{{p}_{{N}_{SS}}^{-}}{\vert {p}_{{N}_{SS}}^{-} \vert} ] . \qquad Eq . ( 11 )$$

Using the normalized precoder, there are additional ways to scale the precoder. There are mainly two choices for the regulatory scaling parameter C: A first approach is to normalize such that each antenna 15 uses fractional power 1. This approach is referred to as full power normalization (FPN). The second approach is to normalize such that the radiated power is equivalent to the hypothetical power that would be radiated by a single perfectly isotropic antenna. This approach is referred to as effective isotropic radiating power (EIRP) limited normalization (ELN).

Based on the system model described above, the FPN approach corresponds to selecting C such that:

$$E \{ {\vert {o}_{t} \vert}^{2} \} = 1. \qquad Eq . ( 12 )$$

From the system model:

$$E \{ {\vert {o}_{t} \vert}^{2} \} = {C}^{2} E \{ {\vert {a}_{t} \vert}^{2} \} = {C}^{2} \frac{{N}_{SS}}{{N}_{T X}} . \qquad Eq . ( 13 )$$

Solving C from Eq. 12 and Eq. 13 gives:

$$C = {C}_{FPN} = \sqrt{\frac{{N}_{T X}}{{N}_{SS}}} . \qquad Eq . ( 14 )$$

Thus, the scaled precoder P is given by:

$$P = {C}_{FPN} {P}^{0} = \sqrt{\frac{{N}_{T X}}{{N}_{SS}}} {P}^{0} . \qquad Eq . ( 15 )$$

Note that if N_{SS}=N_{TX}, the regulatory scaling parameter C_{FPN}=1.

For the ELN approach, there are two sources of increased received power using beamforming: coherence gain and power gain. Coherence gain results from multiple signals coherently combining in the receiver, and the power gain results from each antenna port having has its own PA 60. Assuming the normalized precoder P⁰, the precoder already compensates for the power gain through the normalization of the columns. What remains is to compensate for the coherence gain, which can be done through a scaling factor given by:

$$C = {C}_{ELN} = \frac{1}{\sqrt{{N}_{T X}}} . \qquad Eq . ( 16 )$$

The resulting scaled precoder P is given by:

$$P = {C}_{ELN} {P}^{0} = \frac{1}{\sqrt{{N}_{T X}}} {P}^{0} . \qquad Eq . ( 17 )$$

There are two interesting consequences of the ELN method. First, this method causes the AP 20 to emit less sum-power the more antennas 15 that are used. Second, for each additional spatial stream (SS) added to the transmission, the sum-power emitted by the AP 20 increases.

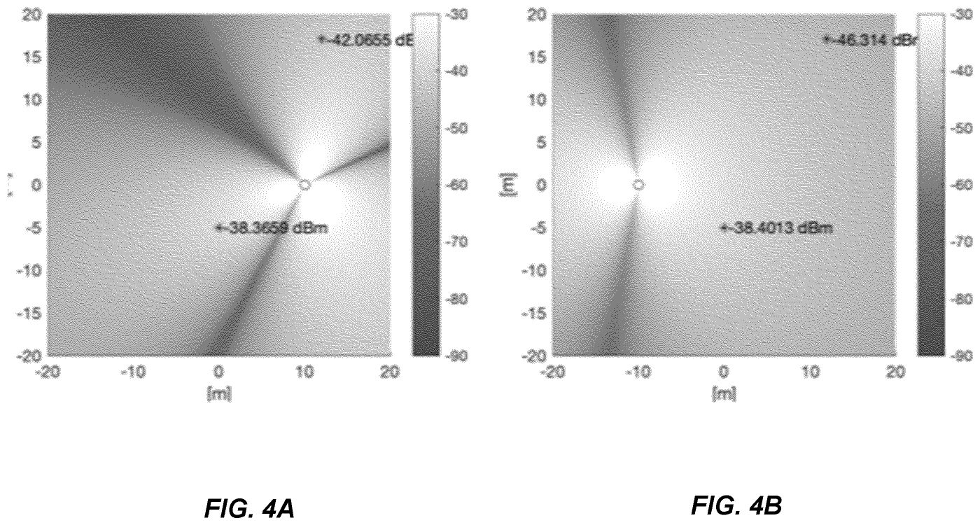

Two examples of the spatial power distribution using the FPN method are depicted in FIGS. 4A and 4B. In this example we use a zero forcing precoder. This means that there is no interference between the two spatial streams. Consequently, the intended receiver may not be precisely in the maximum direction of the beam intended for it, which is visible in FIGS. 4A and 4B.

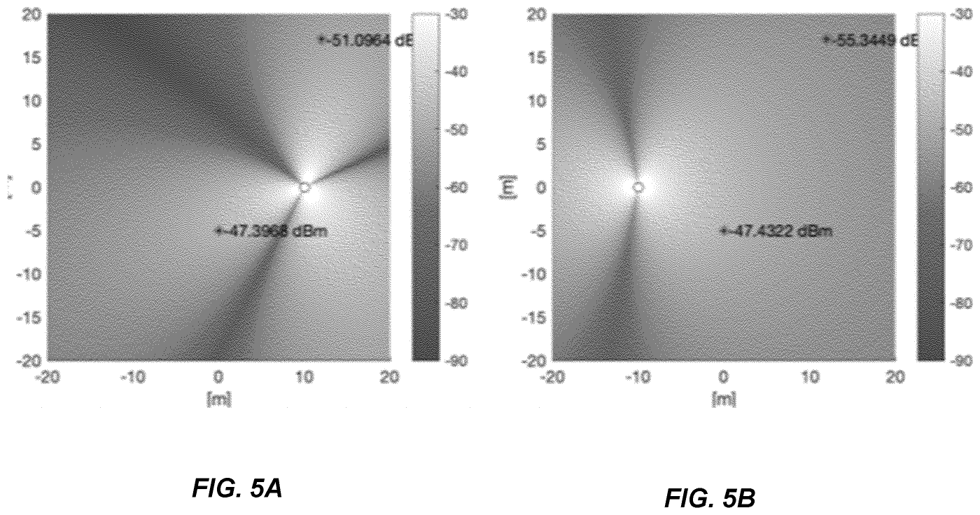

Similarly, we depict two examples of the spatial power distribution using the ELN method depicted in FIGS. 5A and 5B.

In the above, from Eq. (11), a precoder with equal column-norm has been considered. This precoder ensures that each spatial stream is served with the same transmit power. One can also design a precoder such that each spatial stream is served with different power such that the receive power is the same for each spatial stream.

In IEEE 802.11, JT techniques are being considered for Wi-Fi networks. JT is the concurrent data transmission from multiple coordinated access points (APs) to a user equipment (UE) using multiple input, multiple output (MIMO) transmission. With JT, multiple APs transmit simultaneously to one, or several intended receivers. One principle behind JT is to enable a distributed multi-user MIMO (D-MU-MIMO) deployment where antennas 15 from multiple APs operate as if they were part of a single distributed antenna system 10.

While JT is of interest for Wi-Fi network, there are practical challenges to implementing a fully D-MU-MIMO system. One issue is possible channel imbalance if one AP has significantly better channel conditions to the receiver than another AP, and that one AP 20 can already transmit with the maximum number of spatial streams to the receiver. In this case, the participation of that second AP will only improve the performance very slightly. Another issue is that the power amplifier gain accuracy of the participating APs need to be very close (within 0.8 dB) between the sounding phase and data transmission phase. Among participating APs time and phase need to be well aligned to obtain the coherence gain in the receiver. A specific trigger-based protocol has been proposed to address this issue. Another challenge is phase drifting inherent from multiple APs (with their individual clocks) contributing to the transmission.

Due to these and other challenges, JT schemes less demanding than the full D-MU-MIMO scheme will likely be initially introduced in the market while work continues on developing the JT technology. One such scheme may be coordinated beamforming, where neighboring APs attempt to reduce interference through nulling. Another, less complex JT scheme is to design the precoder independently for each participating AP (in contrast to a joint precoder design for full D-MU-MIMO).

One flavor of JT, referred to herein as centralized JT, uses a centralized precoder, which may be thought of as the antennas 15 in the participating APs 20 all belonging to one distributed antenna system 10. This is what most people would think about when they refer to D-MU-MIMO. We refer to this as centralized JT. In a second flavor of JT, referred to herein as distributed JT, separate precoders are derived independently for each AP 20.

For purposes of comparing these different approaches to JT, assume that there be N_{AP} APs 20, each with N_{TX} antennas. For the centralized precoder design, it is in principle possible to have N_{SS}=N_{AP}N_{TX} spatial streams (SS) that are orthogonal to each other. A strict synchronization protocol is required to obtain sufficient time and phase alignment between the APs 20. Even with perfect synchronization, this design is sensitive to channel aging. Also, gain states in the participating APs need to be tightly controlled, which may be challenging in practice.

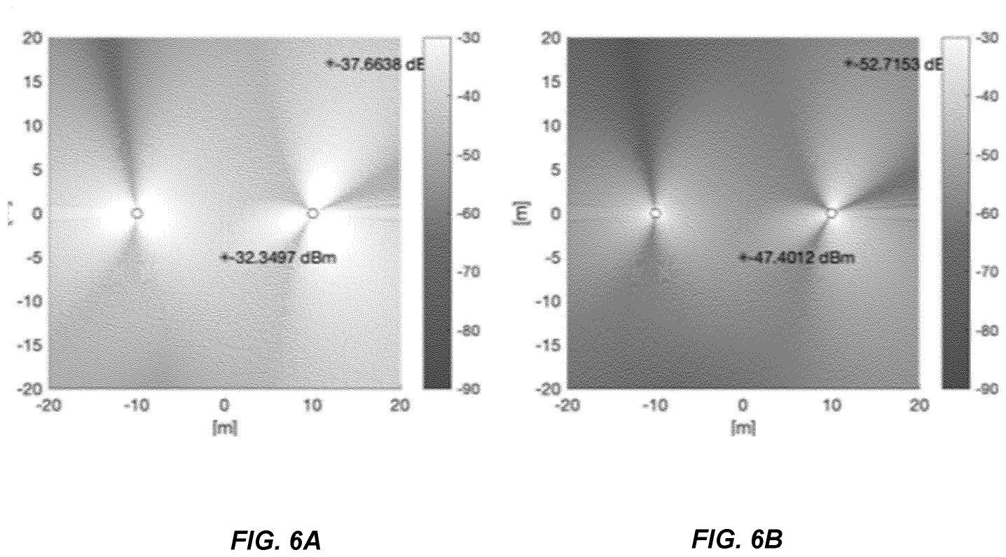

FIGS. 6A and 6B illustrate the emitted power in an exemplary system using a centralized precoder. In FIG. 6A, the centralized precoder is designed with FPN and FIG. 6B, the centralized precoder is designed with the ELN. Note that the ripples shown in FIGS. 6A and 6B is the effect of constructive and destructive interference.

For the independent precoder design, it is possible to have N_{SS}=N_{TX} SSs only that are orthogonal to each other. In the independent precoder design, the SSs between APs are not orthogonal, but the SSs from the same AP may be orthogonal. Further, itis still possible to have N_{SS}=N_{AP}N_{TX} SSs in total, but with uncontrolled interference between the SSs. In the distributed precoder design, the synchronization protocol may be relaxed compared to a joint precoder design and the precoder design is less sensitive to channel aging. The precoder design is also robust to gain states because there is no joint beam steering between the APs 20. It is straight forward to let each AP 20 contribute to independent data streams, eliminating the phase tracking challenge in the joint precoder design.

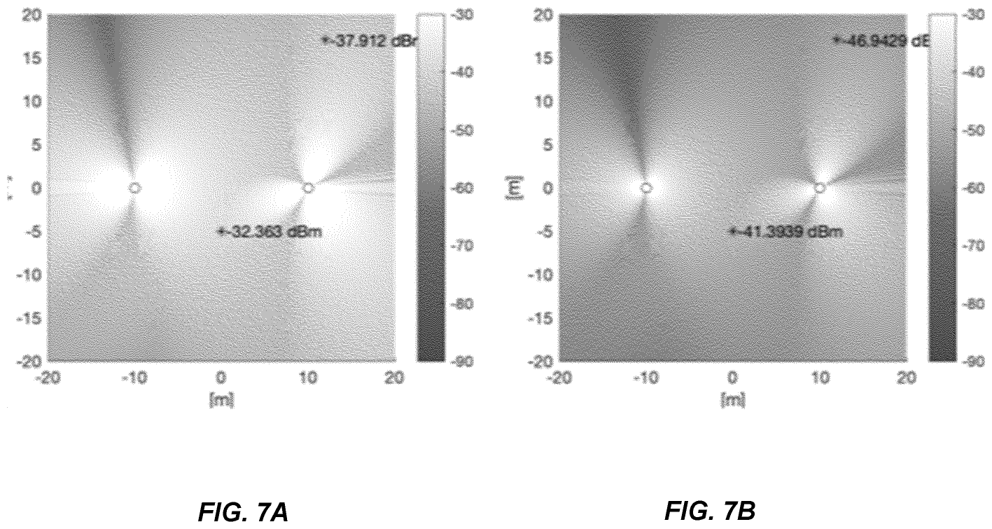

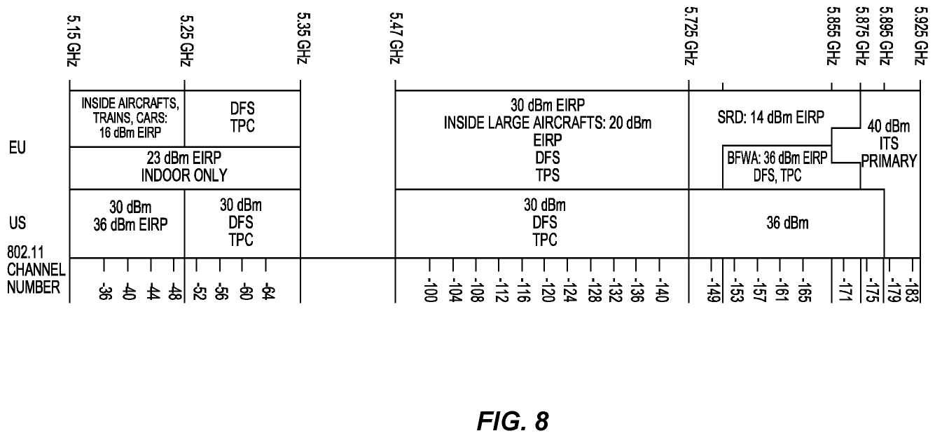

FIGS. 7A and 7B illustrate the emitted power in an exemplary system using a distributed precoder. In FIG. 6A, the distributed precoders are designed with FPN and FIG. 7B, the distributed precoders are designed with the ELN.

In FIGS. 6A, 6B, 7A, and 7B, by visual inspection, is can be noted that the FPN approach in FIGS. 6A and 7A allows for more sum-power in the system compared to the examples shown in FIGS. 4A and 4B. Furthermore, the ELN case in FIG. 7B provides for increased sum-power in the system compared to FIG. 6B.

Current rules and regulations for use of unlicensed spectrum are formed with the assumptions that one transmitting device in an antenna system 10 operates at a time. Using multi-AP techniques such as JT, the number of simultaneous transmitters in the antenna system 10 may significantly increase in the downlink (DL). Additionally, an AP 20 normally has an upper limit on the total number of antennas 15 it can have (for example 8 with IEEE 802.1 lax). However, using JT, the total number of antennas 15 increases with each AP 20 that is added so that that the total emitted power of the antenna system 10 also increases. With JT, the total power could scale infinitely. By allowing full-power JT, a Wi-Fi antenna system 10 may, without new regulations, increase its power without limits by adding APs 20 to the antenna system 20, which may cause severe problems to incumbent services.

One aspect of the present disclosure comprises techniques for scaling the precoders for antenna system 10 implementing either centralized or distributed JT to control the total power emitted by a plurality of antennas 15 distributed among multiple antennas 15 and configured to perform JT. The scaling factor used for scaling the transmit power at each antenna 15 includes a parameter, N_{AP}, indicating a number of APs 20 in the antenna system 10. In introduction of the parameter, N_{AP}, enables the scaling factor to be designed such that the total sum power does not increase when additional APs 20 are added to the antenna system 10. In one embodiment, the total sum power of the antenna system 10 scales according to Table 1 below.

TABLE 1
Example of the antenna system sum-power using JT.

Nr of APs:

| | | | |
|---|---|---|---|
| 1 | 2 | 3 | 4 |

Antenna system sum-power

| | | | | | |
|---|---|---|---|---|---|
| FPN | Prior art | 4 | 8 | 12 | 16 |
| centralized | Invention | 4 | 4 | 4 | 4 |
| FPN | Prior art | 4 | 8 | 12 | 16 |
| distributed | Invention | 4 | 4 | 4 | 4 |
| ELN | Prior art | 0.5 | 0.25 | 0.166 . . . | 0.125 |
| centralized | Invention | 0.5 | 0.25 | 0.166 . . . | 0.125 |
| ELN | Prior art | 0.5 | 1 | 1.5 | 2 |
| distributed | Invention | 0.5 | 0.25 | 0.166 . . . | 0.125 |

In exemplary embodiments, the scaling factor incorporates a power normalization factor K, also referred to as the power normalization factor, in the precoder design that lets the power in an antenna system 10 with multiple APs in a JT scale graciously. In these embodiments, the parameter, N_{AP}, comprises a term in the power normalization factor K. In other embodiments, an additional power scaling factor S is introduced to allow for more emitted power in the antenna system 10. In some embodiments, the parameter, N_{AP}, comprises a term in the scaling parameter S.

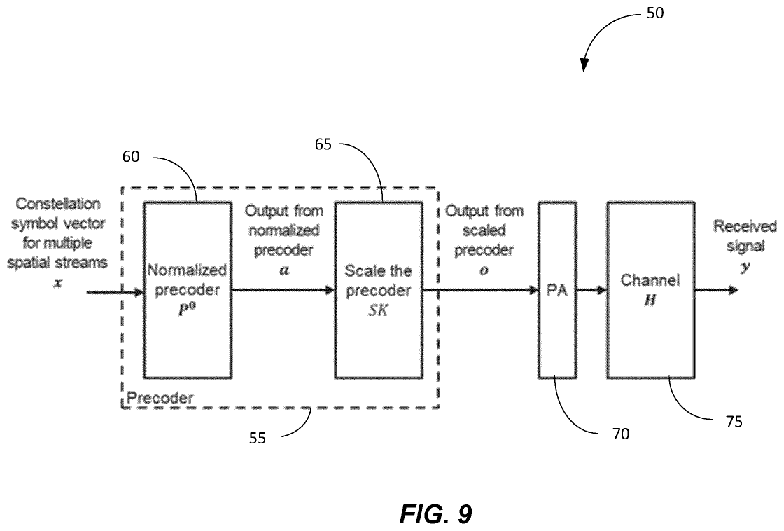

FIG. 9 illustrates a system model 50 incorporating the power normalization factor K and power scaling factor S. This model 50 is similar to the model 50 shown in FIG. 3 except for the design of the precoder scaling where the combined scaling factor SK replaces C in FIG. 3. Therefore, similar reference numbers are used to indicate similar elements. The scaled precoder 55 comprises a precoder 60 normalized using FPN or ELN and a power scaling unit 65 for scaling the output of the precoder 60. In this model, the scaling factor C is replaced by the combined scaling factor SK, which is a product of a first scaling factor K and a second scaling factor S. The choice of K and S depends on the type of JT. In the following description, four types of JT are considered:
centralized JT with FPN regulation
distributed JT with FPN regulation
centralized JT with ELN regulation
distributed JT with ELN regulation

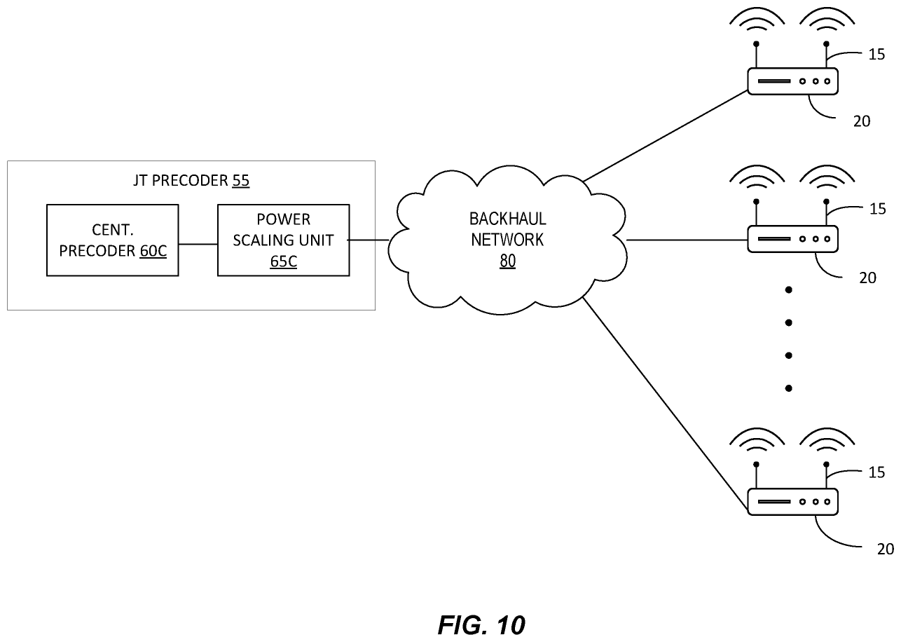

FIG. 10 illustrates an antenna system 10 using a centralized architecture. In the centralized architecture for JT, the JT precoder 55 is located at a central location and is connected by a backhaul antenna system 10 80 to the APs 20 contributing antennas 15 to the antenna system 10. A centralized precoder 60C generates a precoder output for all antennas 15 in the antenna system 10. The precoder output is scaled as herein described by a centralized power scaling unit 65C. The scaled precoder output is then transmitted to the participating APs 20 over the backhaul network 80. In some embodiments, the centralized precoder 60C and power scaling unit 65C could be located at one of the APs 20. In a variation of centralized precoding, distributed scaling could be performed at each of the participating APs 20 because the same scaling is applied to all antennas.

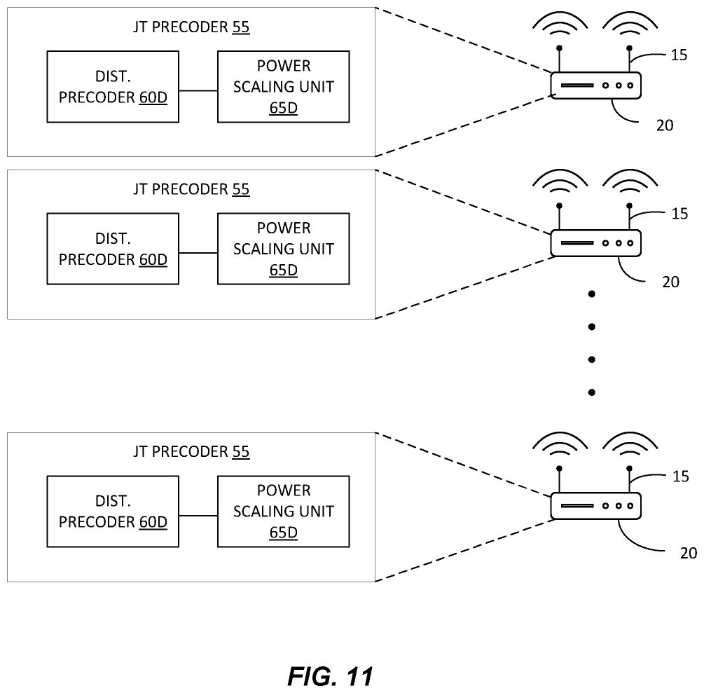

FIG. 11 illustrates an antenna system 10 using a distributed architecture for JT. In the distributed architecture, a JT precoder 55 is located at each AP 20. In this case, a distributed precoder 60D generates a precoder output for the set of antennas 15 in the antenna system 10 contributed by the AP 20. The precoder output is scaled as herein described by a distributed power scaling unit 65D. The scaled precoder output is then output to the set of antennas 15 belonging to the AP 20.

Those skilled in the art will appreciate that variations combining the centralized and distributed approaches are also possible. For example, in an embodiment, centralized precoders 60 could be provided for two or more groups of APs 20 in the antenna system 10. Within each group, the centralized precoder 60 generates the precoder output for all antennas 15 in the group. Between groups, the centralized precoders act as distributed precoders.

For centralized JT with FPN regulation, the sum power P of the antenna system 10 is given by:

$${P}_{FPN , cent} = E \{ {\vert o \vert}^{2} \} = {K}_{FPN , cent}^{2} E \{ {\vert a \vert}^{2} \} = {K}_{FPN , cent}^{2} {N}_{S S} . \qquad Eq . ( 18 )$$

In this embodiment, the sum-power of the antenna system 10 is limited to the total power of 1 AP 20 with the average number of antennas 15

$${N}_{TX , avg} = \frac{{N}_{TX , tot}}{{N}_{A P}}$$

from all participating APs 20. With this assumption, the sum power can be written as:

$${P}_{FPN , cent} = {N}_{TX , avg} = \frac{{N}_{TX , tot}}{{N}_{A P}} \qquad Eq . ( 19 )$$

Solving Eqs. 19 and 20 gives:

$${K}_{FPN , cent} = \sqrt{\frac{{N}_{TX , avg}}{{N}_{A P}}} = \sqrt{\frac{{N}_{TX , tot}}{{N}_{AP} {N}_{SS}}} . \qquad Eq . ( 20 )$$

Comparing Eq. 20 with Eq. 14, the new parameter, N_{AP} appears in the denominator of Eq. 20.

For distributed JT with FPN regulation, the sum power Θ of the antenna system 10 is given by:

$${P}_{FPN , dist} = {\sum }_{i = 1 … {N}_{A P}} E \{ {\vert {o}_{i} \vert}^{2} \} = {\sum }_{i = 1 … {N}_{A P}} {K}_{FPN , dist , i}^{2} {N}_{SS , i} \qquad Eq . ( 21 )$$

In Eq. 21, N_{SS,i} is the number of spatial streams at AP i, and N_{TX,i} is the number of transmit antennas 15 at AP i. Again, we want to limit the sum-power of the antenna system 10 to the total power of 1 AP with the average number of antennas.

$${P}_{FPN , dist} = {N}_{TX , avg} = \frac{{N}_{TX , tot}}{{N}_{A P}} . \qquad Eq . ( 22 )$$

Preferably, the scaling factor is the same for all

$$APs {K}_{FPN , dist , i}^{2} = {K}_{FPN , dist}^{2} .$$

For simplicity, it is assumed that the number of spatial streams at each AP is also the same N_{SS,i}=N_{SS}, but this is not a requirement. With these assumptions, each AP contributes to all transmissions in the antenna system 10, which implies a stricter limit to the total number of spatial streams compared to a centralized JT, N_{SS}≤N_{TX,i} ∀i∈i=1 . . . N_{AP}.

A solution to Eqs. 21 and 22 is given by:

$${K}_{FPN , dist} = \frac{1}{{N}_{A P}} \sqrt{\frac{{N}_{TX , tot}}{{N}_{SS}}} . \qquad Eq . ( 23 )$$

For centralized JT with ELN regulation, the sum power Θ of the antenna system 10 is given by:

$${P}_{ELN , cent} = E \{ {\vert o \vert}^{2} \} = {K}_{ELN , cent}^{2} {N}_{S S} . \qquad Eq . ( 24 )$$

Using the ELN antenna system 10 regulation, the antenna system 10 scales the transmit sum-power with the number of spatial streams where each stream can only use the equivalent power of a single antenna. With this assumption, the sum power can be written as:

$${P}_{ELN , cent} = \frac{{N}_{SS}}{{N}_{TX , tot}} . \qquad Eq . ( 25 )$$

Solving Eqs. 24 and 25, the first factor K is obtained:

$${K}_{ELN , cent} = \frac{1}{\sqrt{{N}_{TX , tot}}} . \qquad Eq . ( 26 )$$

Note that Eq. 26 typically implies that the more APs 20 participating in the JT, the larger is the N_{TX}, and thus the smaller the antenna system 10 sum-power.

In this case, the first factor K does not incorporate the parameter N_{AP}. However, the second scaling factor S can incorporate the N_{AP}. parameter as will be herein after described.

For distributed JT with ELN regulation, the sum power Θ of the antenna system 10 is given by:

$${P}_{ELN , dist} = {\sum }_{i = 1 … {N}_{A P}} E \{ {\vert {o}_{i} \vert}^{2} \} = {\sum }_{i = 1 … {N}_{A P}} {K}_{ELN , dist , i}^{2} {N}_{SS , i} . \qquad Eq . ( 27 )$$

Using the ELN antenna system 10 regulation, the antenna system 10 scales the transmit sum-power with the number of spatial streams where each stream can only use the equivalent power of a single antenna, that is,

$${P}_{ELN , dist} = \frac{{N}_{SS}}{{N}_{TX , tot}} . \qquad Eq . ( 28 )$$

Preferably, the scaling factor is the same for all

$$APs {K}_{ELN , dist , i}^{2} = {K}_{ELN , dist}^{2} .$$

Also, for simplicity, it is assumed that the number of spatial streams at each AP is the same N_{SS,i}=N_{SS}. These assumption means that each AP contributes to all transmissions in the antenna system 10, which implies a stricter limit to the total number of spatial streams compared to the centralized JT, N_{SS}≤N_{TX,i} ∀i∈i=1 . . . N_{AP}.

Solving Eqs. 27 and 28 gives:

$${K}_{ELN , dist} = \sqrt{\frac{1}{{N}_{TX , tot} {N}_{A P}}} . \qquad Eq . ( 29 )$$

In the FPN examples described above, the power emitted by the antenna system 10 is limited such that using more APs 20 does not increase the sum-power in the antenna system 10. It may be reasonable in some cases to allow for additional emitted power compared to this baseline so the second scaling factor S is introduced to enable higher transmit powers that would be the case for a single AP 20 using conventional methods. For the FPN case, there are four main choices for the second scaling factor S_{FPN}.
S_{FPN}=1.
S_{FPN}=min(\sqrt{N_{AP}},\sqrt{N_{SS}}). This scaling factor means that the antenna system 10 sum-power will scale with the number of SS, each SS be given the power corresponding to 1 AP with the power of the average number of antennas.
S_{FPN}=min(\sqrt{N_{AP}},\sqrt{N_{STA}}). This scaling factor means that the antenna system 10 sum-power will scale with the number of STAs.

$${S}_{FPN} = min ( \sqrt{{N}_{A P}} , \sqrt{\frac{{N}_{AP} R}{{N}_{TX} , tot}} ) .$$

This scaling factor adds another term R. The idea is that R is the maximum number of antennas 15 allowed by the regulation, where each antenna 15 can contribute with its full power. For example, if the regulation allows for an AP with 16 antennas 15, and we have 2 APs with 8 antennas 15 each, these two APs are allowed to use the full power.

For ELN, the sum-power of the antenna system 10 scales with N_{SS}. This result is inherited from the idea that each spatial stream is orthogonal and the limit is on the strength of each beam. However, in multi-AP transmission, the APs 20 are typically not co-located, and the radiated power from each AP 20 will be in a different direction so additional scaling of N_{AP}. can be allowed. There are two reasonable choices of second scaling factor S_{ELN}:
S_{ELN}=1.
S_{ELN}=N_{AP}. Note that with this second scaling factor, the antenna system 10 will contribute with the sum-power equivalent to 1 AP with the average number of antennas 15 among all participating APs (using ELN regulation).

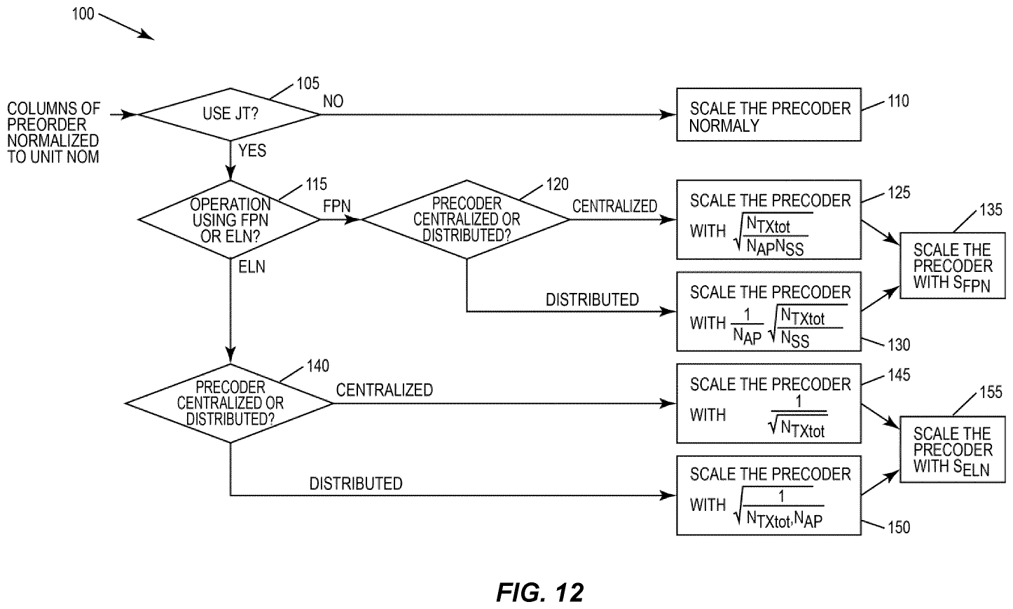

FIG. 12 illustrates an exemplary method 100 of scaling precoder output performed by an AP in an antenna system 10 implementing JT. The method 100 can be performed by a centralized precoder or a distributed precoder. When the columns of a precoder normalized to unit norm are obtained, the power scaling unit in the precoder determines whether JT is enabled (block 105). If not, scaling according to conventional methods described above is applied (block 110). If JT is enabled, the power scaling unit in the precoder determines the type of regulation (FPN or ELN) being used (block 115). After determining the type of regulation, the power scaling unit determines the type of JT (centralized or distributed) (blocks 120, 140). If centralized precoding with FPN regulation is selected, the precoder output is scaled according to Eq. 21 (block 125). If distributed precoding with FPN regulation is selected, the precoder output is scaled according to Eq. 21 (block 130). In either case, the second scaling factor S_{FPN} can optionally be applied (block 135). If centralized precoding with ELN regulation is selected, the precoder output is scaled according to Eq. 21 (block 145). If distributed precoding with ELN regulation is selected, the precoder output is scaled according to Eq. 21 (block 150). In either case, the second scaling factor S_{ELN} can optionally be applied (block 155).

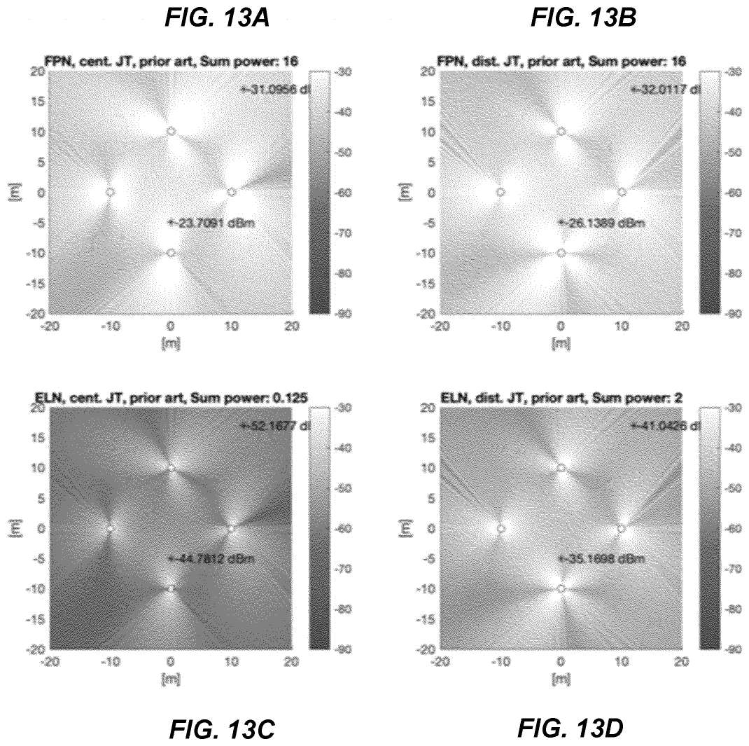

FIGS. 13A-13D illustrates emitted power in an antenna system 10 where N_{AP}=4 and N_{TX}=4 using conventional scaling. FIG. 13A shows centralized JT with FPN regulation. FIG. 13B shows distributed JT with FPN regulation. FIG. 13C shows centralized JT with ELN regulation. FIG. 13D shows distributed JT with ELN regulation. This examples are provided for purposes of comparison with JT using scaling as herein described.

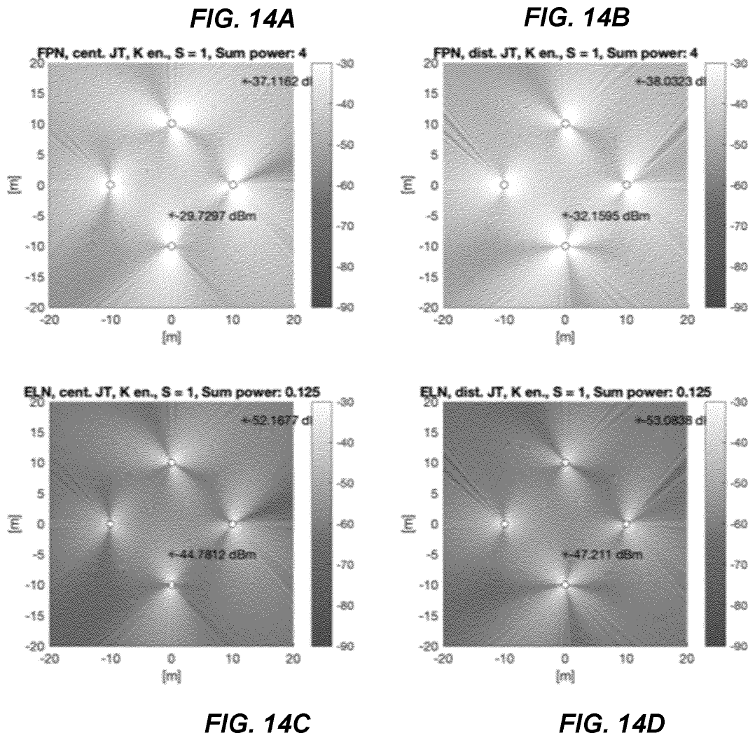

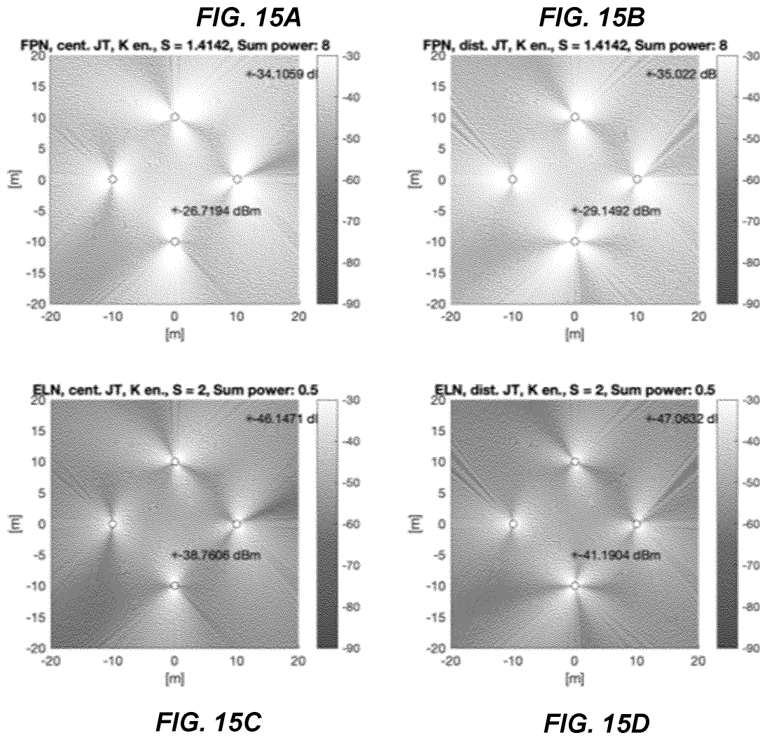

FIGS. 14A-14D illustrates emitted power in an antenna system 10 where N_{AP}=4 and N_{TX}=4 using scaling as herein described when the second scaling factor S_{FPN}=1 and S_{ELN}=1. FIG. 14A shows centralized JT with FPN regulation. FIG. 14B shows distributed JT with FPN regulation. FIG. 14C shows centralized JT with ELN regulation. FIG. 14D shows distributed JT with ELN regulation. These examples are provided for purposes of comparison with JT using scaling as herein described.

FIGS. 15A-15D illustrates emitted power in an antenna system 10 where N_{AP}=4 and N_{TX}=1 using scaling as herein described when the second scaling factor S_{FPN}=min(\sqrt{N_{AP}},\sqrt{N_{SS}})=\sqrt{2} and S_{ELN}=\sqrt{N_{AP}}. FIG. 1A shows centralized JT with FPN regulation. FIG. 15B shows distributed JT with FPN regulation. FIG. 15C shows centralized JT with ELN regulation. FIG. 15D shows distributed JT with ELN regulation. This example is provided for purposes of comparison with JT using scaling as herein described.

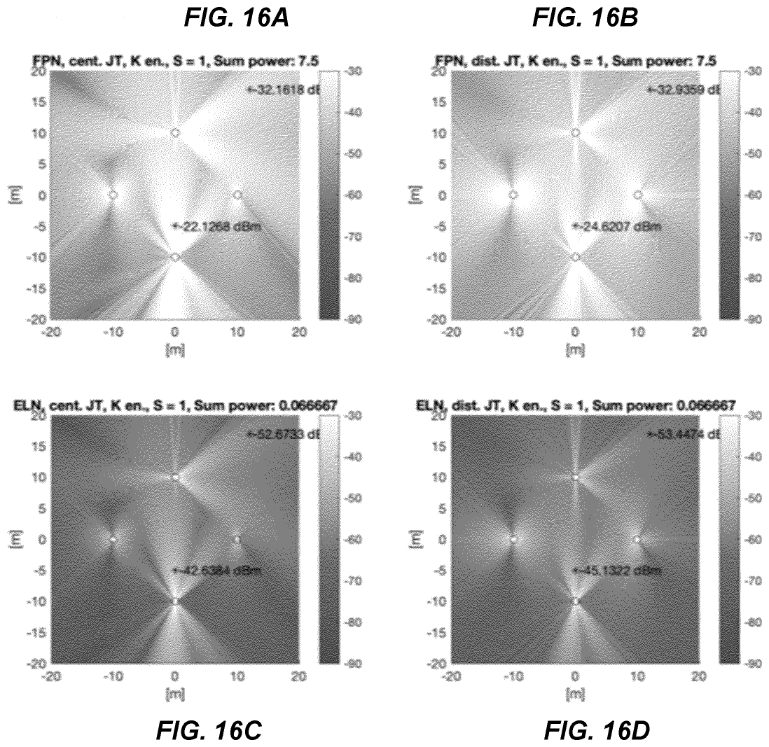

FIGS. 16A-16D illustrates emitted power in an antenna system 10 where N_{AP}=4 and the APs 20 have different numbers of antennas. In this example, N_{TX,1}=2, N_{TX,2}=4, N_{TX,3}=8, N_{TX,4}=16. FIG. 16A shows centralized JT with FPN regulation. FIG. 16B shows distributed JT with FPN regulation. FIG. 16C shows centralized JT with ELN regulation. FIG. 16D shows distributed JT with ELN regulation. These examples are provided for purposes of comparison with JT using scaling as herein described.

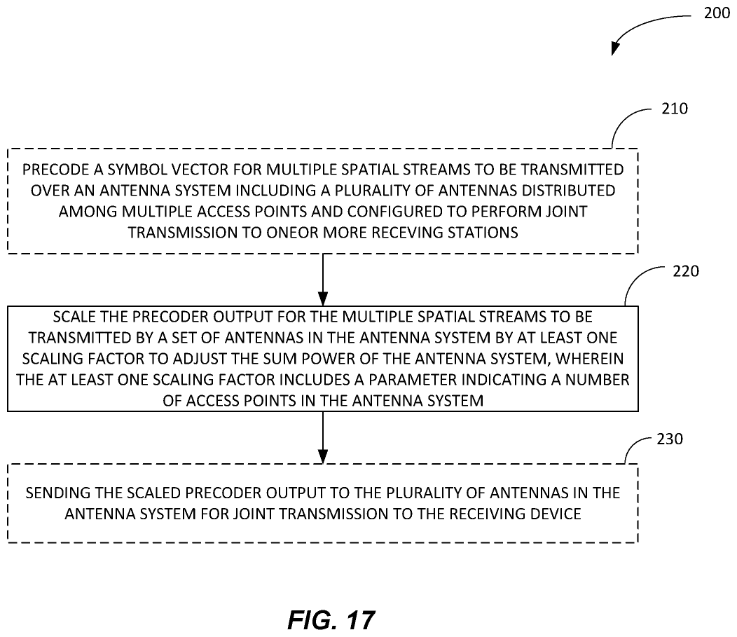

FIG. 17 illustrates an exemplary method 200 of controlling transmit power in an antenna system 10 including a plurality of antennas 15 distributed among multiple APs 20 and configured to perform joint transmission to one or more receiving stations 25. The method 200 may be performed by a power scaling unit 65, JT precoder 55, or AP 20. After a symbol vector has been precoded, the precoder output for multiple spatial streams to be transmitted by set of antennas 15 in the antennas system 10 is scaled by at least one scaling factor to adjust the sum power of the antenna system 10 (block 220). The at least one scaling factor comprises a parameter, N_{AP}, indicating a number of APs 20 in the antenna system 10.

Some embodiments of the method 200 further comprise precoding the symbol vector for the plurality of spatial streams to be transmitted over the antenna system 10 to generate the precoder output (block 210).

In some embodiments of the method 200, the scaling comprises full power normalization (FPN) such that each of the plurality of antennas 15 uses fractional power 1.

In some embodiments of the method 200 using FPN, the precoder output is provided by a centralized precoder and the scaling is performed for all antennas 15 in the antenna system 10.

In some embodiments of the method 200 using FPN, the precoder output is provided by a distributed precoder and the scaling is performed for a subset of antennas 15 in the antenna system 10 associated with the distributed precoder.

In some embodiments of the method 200 using FPN, the at least one scaling factor comprises a first scaling factor which is a function of a number of antennas 15 in the antenna system 10, N_{TX,tot}, a number of spatial streams, N_{SS}, and the parameter, N_{AP}.

In some embodiments of the method 200 using FPN, the first scaling factor is:

$$\sqrt{\frac{{N}_{TX , tot}}{{N}_{A P} {N}_{S S}}}$$

In some embodiments of the method 200 using FPN, the first scaling factor is:

$$\frac{1}{{N}_{AP}} \sqrt{\frac{{N}_{TX , tot}}{{N}_{SS}}}$$

In some embodiments of the method 200 using FPN, the at least one scaling factor comprises a second scaling factor selected such that the sum power of the antenna system 10 scales with the number of spatial streams, \sqrt{N_{SS}}.

In some embodiments of the method 200, the second scaling factor is:

$$min ( \sqrt{{N}_{AP}} , \sqrt{{N}_{SS}} )$$

In some embodiments of the method 200 using FPN, the at least one scaling factor comprises a second scaling factor selected such that the sum power of the antenna system 10 scales with the number of receiving stations (25), N_{STA}.

In some embodiments of the method 200 using FPN, the second scaling factor is:

$$min ( \sqrt{{N}_{AP}} , \sqrt{{N}_{STA}} )$$

In some embodiments of the method 200 using FPN, the at least one scaling factor comprises a second scaling factor selected such that the sum power of the antenna system 10 scales with a maximum number of antennas 15 allowed by regulation factor, R.

In some embodiments of the method 200, the second scaling factor is:

$$min ( \sqrt{{N}_{AP}} , \sqrt{\frac{{N}_{AP} R}{{N}_{TX , tot}}} )$$

In some embodiments of the method 200 using FPN, R=8 or 16.

In some embodiments of the method 200, the scaling comprises effective isotropic radiated power (EIRP) normalization.

In some embodiments of the method 200 using EIRP, the precoder output is provided by a centralized precoder and the scaling is performed for all antennas 15 in the antenna system 10.

In some embodiments of the method 200 using EIRP, the precoder output is provided by a distributed precoder and the scaling is performed for a subset of antennas 15 in the antenna system 10 associated with the distributed precoder.

In some embodiments of the method 200 using EIRP normalization, the at least one scaling factor comprises a first scaling factor which is a function of a number of antennas 15 in the antenna system 10.

In some embodiments of the method 200 using EIRP normalization, the first scaling factor is:

$$\frac{1}{\sqrt{{N}_{TX , tot}}}$$

In some embodiments of the method 200 using EIRP normalization, the first scaling factor is:

$$\frac{1}{\sqrt{{N}_{TX , tot} {N}_{AP}}}$$

In some embodiments of the method 200 using EIRP normalization, the scaling factor comprises a second scaling factor which is a function of the parameter.

In some embodiments of the method 200, the second scaling factor is:

$$\sqrt{{N}_{AP}}$$

In some embodiments of the method 200 using EIRP normalization, the second scaling factor is 1.

Some embodiments of the method further comprise sending scaled precoder output to the plurality of antennas 15 in the antenna system 10 for joint transmission to the receiving device (block 230).

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

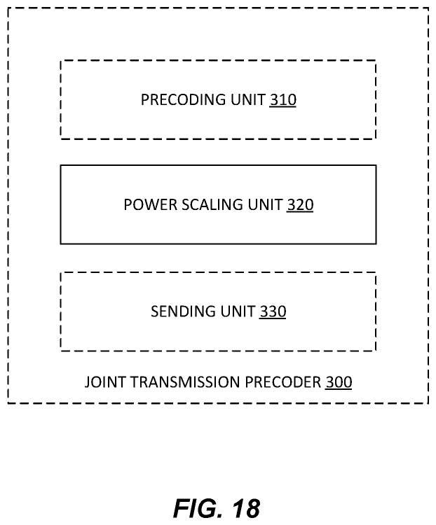

FIG. 18 illustrates a JT precoder 300 in an antenna system 10 including plurality of antennas 15 distributed among multiple APs 20 and configured to perform joint transmission to one or more receiving stations. The JT precoder 300 comprises An optional precoding unit 310, a power scaling unit 320, and an optional sending unit 330. The various unit 310-320 can be implemented by hardware and/or by software code that is executed by one or more processors or processing circuits. The precoding unit 310 is configured to precode a symbol vector for the plurality of spatial streams to be transmitted over the antenna system 10 to generate the precoder output. The precoding unit 310 may comprise, for example, a MIMO precoder. The power scaling unit 320 is configured to scale the precoder output from the precoding unit 310 for multiple spatial streams to be transmitted by a set of antennas 15 in the antenna system 10 by a scaling factor to adjust the sum power of the antenna system 10. The scaling factor comprises a parameter, N_{AP}, indicating a number of APs 20 in the antenna system 10. The sending unit 330, when present, is configured to send scaled precoder output to a set of antennas 15 in the antenna system 10 for joint transmission to the one or more receiving stations 25. The set of antennas 15 may comprise the antennas 15 at all APs 20 in the antenna system 10, at a group of APs 20 in the antenna system 10, or at a single AP 20. The JT precoder 300 may comprises a stand-alone network node or, alternatively, maybe incorporated into an AP 20 in the antenna system 10 to perform distributed or centralized precoding as herein described.

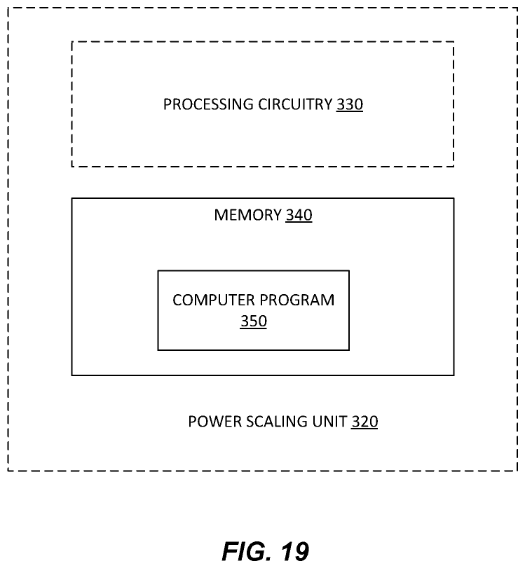

FIG. 19 illustrates an embodiment of the power scaling unit 320 for the JT precoder 300. The power scaling unit 320 comprises processing circuitry 330 and memory 340 storing executable code that configures the processing circuitry 330 to perform power scaling of precoder output as herein described. The executable code comprises instructions executable by the processing circuitry 330 such that the power scaling unit 300 is operative to scale precoder output for multiple spatial streams to be transmitted by a set of antennas 15 in antenna system 10 by a scaling factor to adjust the sum power of the antenna system 10. The scaling factor comprises a parameter, N_{AP}, indicating a number of APs in the antenna system 10. In some embodiments, the processing circuitry 330 is further configured to send scaled precoder output to a set of antennas 15 in the antenna system 10 for joint transmission to the one or more receiving stations 25. The set of antennas 15 may comprise the antennas 15 at all APs 20 in the antenna system 10, at a group of APs 20 in the antenna system 10, or at a single AP 20. In some embodiments, the processing circuitry 330 may be further configured to generate the precoder output before power scaling. The power scaling unit 320 can be implemented as a stand-alone unit or as part of a JT precoder or AP 20.

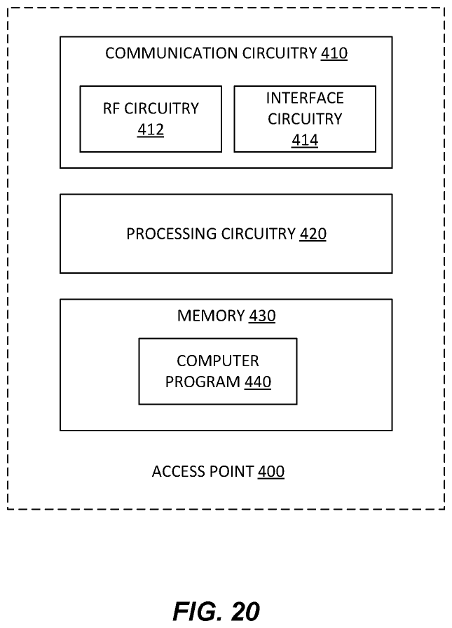

FIG. 20 illustrates an AP 400 in an antenna system including a plurality of antennas 15 distributed among multiple APs 20 and configured to perform joint transmission to one or more receiving stations 25. The AP 400 comprises communication circuitry 410, a processing circuitry 420, and memory 430. The communication circuitry 410 comprises radio frequency (RF) circuitry 412 coupled to one or more antennas 15 (not shown) for communicating with the receiving stations 25 serving by the AP 20. The radio frequency circuitry 412 may comprise a RF transmitter and RF receiver configured to operate according to any wireless communication standard. Communication circuitry 410 may further comprise interface circuitry 414 for communicating over a backhaul network with other APs 20 in the antenna system 10. The interface circuitry 414 may be used, for example, to send the scaled precoder output to other APs 20 in the antenna system, or for communicating configuration information or other information needed to perform joint transmission.

The processing circuitry 420 controls the overall operation of the AP 400 The processing circuitry 420 may comprise one or more microprocessors, digital signal processors, field programmable gate arrays (FPGAs), application specific integrated circuits), hardware, firmware, or a combination thereof. In exemplary embodiments, the processing circuitry 420 is configured by program instructions stored in memory 430 to perform one or more of the methods 100, 200 shown in FIGS. 12 and 17, respectively. In one embodiment, the processing circuitry 420 is configured to scale a precoder output for multiple spatial streams to be transmitted by a set of antennas 15 in the antenna system 10 by at least one scaling factor to adjust the sum power of the antenna system 10; wherein the at least one scaling factor comprises a parameter indicating a number of access points 20 in the antenna system 10. In some embodiments, the processing circuitry 420 may be further configured to generate the precoder output before power scaling. The processing circuitry 420 may be further configured to send scaled precoder output to a set of antennas 15 in the antenna system 10 for transmission to one or more receiving stations 25. The set of antennas 15 may comprise the antennas 15 at all APs 20 in the antenna system 10, at a group of APs 20 in the antenna system 10, or at a single AP 20.

Memory 430 comprises both volatile and non-volatile memory for storing computer program code and data needed by the processing circuitry 420 for operation. Memory 430 may comprise any tangible, non-transitory computer-readable storage medium for storing data including electronic, magnetic, optical, electromagnetic, or semiconductor data storage. Memory 430 stores a computer program 440 comprising executable instructions that configure the processing circuit 420 in the AP 400 to perform one or more of the methods 100, 200 shown in FIGS. 12 and 17, respectively. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 440 for configuring the processing circuitry 420 as herein described may be stored in a removable memory, such as a portable compact disc, portable digital video disc, or other removable media. The computer program 440 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

1-32. (canceled)

33. A method of controlling transmit power in an antenna system including a plurality of antennas distributed among multiple access points and configured to perform joint transmission to one or more receiving stations, the method comprising:
scaling a precoder output for multiple spatial streams to be transmitted by a set of antennas in the antenna system by at least one scaling factor to adjust the sum power of the antenna system; and
wherein the at least one scaling factor comprises a parameter, N_{AP}, indicating a number of access points (APs) in the antenna system.

34. The method of claim 33, wherein the at least one scaling factor comprises a first scaling factor which is a function of a number of antennas in the antenna system, N_{TX,tot}, a number of spatial streams, N_{SS}, and the parameter, N_{AP}.

35. The method of claim 34, wherein the first scaling factor is:
$$\sqrt{\frac{{N}_{TX , tot}}{{N}_{AP} {N}_{SS}}} .$$

36. The method of claim 34, wherein the first scaling factor is:
$$\frac{1}{{N}_{AP}} \sqrt{\frac{{N}_{TX , tot}}{{N}_{SS}}} .$$

37. The method of claim 35, wherein the at least one scaling factor comprises a second scaling factor selected such that the sum power of the antenna system scales with the number of spatial streams, \sqrt{N_{SS}}.

38. The method of claim 37, wherein the second scaling factor is:
$$min ( \sqrt{{N}_{AP}} , \sqrt{{N}_{SS}} ) .$$

39. The method of claim 35, wherein the at least one scaling factor comprises a second scaling factor selected such that the sum power of the antenna system scales with the number of receiving stations, N_{STA}.

40. The method of claim 39, wherein the second scaling factor is:
$$min ( \sqrt{{N}_{AP}} , \sqrt{{N}_{STA}} ) .$$

41. The method of claim 35, wherein the at least one scaling factor comprises a second scaling factor selected such that the sum power of the antenna system scales with a maximum number of antennas allowed by regulation, R.

42. The method of claim 9, wherein the second scaling factor is:
$$min ( \sqrt{{N}_{AP}} , \sqrt{\frac{{N}_{AP} R}{{N}_{TX , tot}}} ) .$$

43. The method of claim 33, wherein the at least one scaling factor comprises effective isotropic radiated power (EIRP) normalization.

44. The method of claim 43, wherein the at least one scaling factor comprises a first scaling factor which is a function of a number of antennas in the antenna system.

45. The method of claim 44, wherein the first scaling factor is:
$$\frac{1}{\sqrt{{N}_{TX , tot}}} .$$

46. The method of claim 44, wherein the first scaling factor is:
$$\sqrt{\frac{1}{{N}_{TX , tot} {N}_{AP}}} .$$

47. The method of claim 45, wherein the at least one scaling factor comprises a second scaling factor which is a function of the parameter, N_{AP}.

48. The method of claim 47, wherein the second scaling factor is:
$$\sqrt{{N}_{AP}} .$$

49. The method of claim 46, wherein the second scaling factor is 1.

50. The method of claim 33, further comprising sending scaled precoder output to the set of antennas in the antenna system for joint transmission to the one or more receiving stations.

51. A power scaling unit for controlling the transmit power in an antenna system including plurality of antennas distributed among multiple access points and configured to perform joint transmission to one or more receiving stations, the power scaling being configured to:
scale a precoder output for multiple spatial streams to be transmitted by a set of antennas in the antenna system by at least one scaling factor to adjust the sum power of the antenna system; and
wherein the at least one scaling factor comprises a parameter indicating a number of access points in the antenna system.
